(19) United States
(12) Patent Application Publication
(10) Pub. No.: US 2016/0215550 A1
(43) Pub. Date: Jul. 28, 2016

(54) HINGE

(71) Applicant: UNION INDUSTRY INVESTMENT (SHENZHEN) CO., LTD., Shenzhen (CN)

(72) Inventor: Yousong XIAO, Shenzhen (CN)

(73) Assignee: UNION INDUSTRY INVESTMENT (SHENZHEN) CO., LTD., Shenzhen (CN)

(21) Appl. No.: 14/916,129

(22) PCT Filed: Sep. 2, 2013
(86) PCT No.: PCT/CN2013/082780

§ 371 Date: Mar. 2, 2016

(51) Int. Cl. E05F 1/12; E05D 7/12

(52) U.S. Cl. CPC E05F 1/1276; E05D 7/12; E05Y 2900/308

(57) ABSTRACT

The utility model provides a hinge, including a hinge base (1), a hinge arm (2) movably arranged with the hinge base (1), and a supporting frame (3) and a bracket (5) arranged between the hinge base (1) and the hinge arm (2), wherein a rocker arm (6) and a spring connecting rod (8) are arranged in cooperation with the bracket (5), a first spring (7) is arranged between the rocker arm (6) and the bracket (5), a second spring (9) is sleeved on the spring connecting rod (8), a roller (61) is arranged in cooperation with the rocker arm (6), and clamping positions (21) which are mutually clamped when the rocker arm (6) and the hinge arm (2) are located at first limit positions and side faces of the hinge arm (2) which are mutually propped when the rocker arm (6) and the hinge arm (2) are located at second limit positions are arranged on the hinge arm (2) in cooperation with the roller (61). By means of this structure, the hinge can provide a balance force within a large angle and a buffering force for an oven door body, can have a certain pressure holding force when being closed and has a simple structure, and meanwhile, the hinge further has the advantage that an oven door and an oven body are easy to demount.

### FIELD OF THE UTILITY MODEL

The utility model relates to a hinge, and in particular, to a hinge for an oven door body.

### BACKGROUND OF THE INVENTION

With the gradual improvement of the living standards of people, an oven used for preparing and cooking food has gradually become one of the daily tools of people, the oven includes an oven body and a door body mounted on a front side of the oven body, when in use, the door body is opened at first, then food is put in the oven, and the door body is closed to roast the food. For a common oven, the oven body and the door body thereof are connected by an ordinary hinge, when the door body is closed, the door body is clamped on the oven body, when the door body is opened, the door body stays in a horizontal state, if it is expected to make the door body stay at any angle, a user needs to apply a certain supporting force to the door body, after the oven is used and heat dissipation is needed, the door body can be only completely opened and is in the horizontal state, so that more space will be occupied, and some inconvenience is brought to the user.

Of course, these hinges basically have to rely on the tension of springs and adopt a reverse traction mode, when needing to open the door, the oven door is opened to elongate the spring to open the oven door, and when needing to close the oven door, the oven door is only released, and the oven door will be closed due to the resetting function of the spring. In practical use, since the reset of the spring has a certain acceleration, when the oven door is about to close, the kinetic potential is the largest, the speed is faster, the oven is damaged easily if suffering this collision for a long time, the general practice is to adhere a damping material on a doorsill, such as sponge, however, in this practice, the tension spring still has very large potential and is still damaged easily. In summary, a problem needing to be solved at present is development of an oven hinge capable of automatically decelerating at a certain position to avoid colliding the oven doorsill to result in easy damage of the doorsill or the hinge; of course, for example, although an oven hinge as mentioned in the published text of CN201020193660.3 can solve the above problems, the structure is complex, and the entirety needs to be adjusted in applications of different types ovens.

### SUMMARY OF THE UTILITY MODEL

The object of the utility model is to provide a hinge, which can provide a balance force within a large angle and a buffering force for an oven door body, can have a certain pressure holding force when being closed and has a simple structure, and meanwhile the hinge further has the advantage that an oven door and an oven body are easy to demount.

To achieve the above object, the utility model adopts the following technical solutions:

the hinge includes a hinge base, a hinge arm movably arranged with the hinge base, and a supporting frame and a bracket arranged between the hinge base and a movable arm, the supporting frame and the bracket respectively include two clamping pieces arranged in parallel, a rocker arm and a spring connecting rod are arranged in cooperation with the bracket, a first spring is arranged between the rocker arm and the bracket, a second spring is sleeved on the spring connecting rod, the rocker arm body includes two clamping pieces arranged in parallel, a first end hole is arranged on the rocker arm body, a rocker arm rivet penetrates through the first end hole of the rocker arm, a roller is sleeved on the rocker arm rivet and is clamped in the two parallel clamping pieces of the rocker arm body, and clamping positions which are mutually clamped when the rocker arm and the hinge arm are located at first limit positions and side faces of the hinge arm which are mutually propped when the rocker arm and the hinge arm are located at second limit positions are arranged on the hinge arm in cooperation with the roller.

A center hole is further arranged on the rocker arm body, a middle slot hole is arranged on the body of the corresponding bracket, a fixing hole is arranged on the hinge seat, and a shaft penetrates through the center hole, the middle slot hole and the fixing hole for coaxially connecting the rocker arm, the bracket and the hinge seat.

A second end hole is arranged on the other end of the rocker arm body, a connecting shaft penetrates through the second end hole, and a first end hook of the first spring is hung on the connecting shaft and is clamped by the two parallel clamping pieces of the rocker arm body.

A first seat hole is arranged on a first end of the connecting seat, a first connecting hole is correspondingly arranged on the first end of the hinge arm, and the hinge arm is movably connected with the connecting seat by a hinge rivet penetrating through the first seat hole and a hinge sleeve sleeved on the hinge rivet.

A clamping hole is arranged at a top end of the hinge seat, a clamping shaft is correspondingly arranged, and a second end of the first spring is hung on the clamping shaft.

An elongated slot is arranged on the body of the hinge seat, a mounting hole is arranged in the first end of the spring connecting rod, a second bracket hole is arranged on the second end of the bracket, and a long shaft sequentially penetrates through the second bracket hole, the mounting hole and the elongated slot for coaxially connecting the hinge seat, the spring connecting rod and the bracket.

A bracket end hole is arranged on the first end of the bracket, a hinge hole is correspondingly arranged on the hinge arm, a bracket rivet penetrates through the bracket end hole and the hinge hole for coaxially connecting the bracket with the hinge seat, and an oilless bearing is sleeved on the bracket rivet and is clamped by the two parallel clamping pieces of the bracket.

A top hole is arranged at a top of the hinge arm, a supporting hole is arranged on the second end of the supporting frame, and a supporting rivet penetrates through the top hole and the supporting hole for coaxially connecting the hinge arm and the supporting frame.

A neck is arranged on the other end of the spring connecting rod, and a pin shaft penetrates through the neck for limiting the other end of the second spring.

A circular boss (27) is arranged on the hinge arm for controlling a rotation angle of the supporting frame.

By means of the above technical solutions, the utility model has the following beneficial effects:

by means of the above simple structure, it can be ensured that the hinge is maintained at a balance angle of 25-85 degrees when the door body is opened; when the door body is opened, the hinge arm of the hinge is rotated to pull the second spring serving as a pressure spring, a supporting force is provided for the hinge arm by the bracket, and the hinge arm and the door body can stay at any angle between 25 and 85 degrees; when the door body is closed, the door body drives the hinge arm to rotate, under the tension of the first spring serving as a tension spring, a pressure is provided for the roller by the rocker arm, the roller is propped against the side face of the hinge arm, so that the door body is quickly closed within 25 degrees, and the door body has a certain pressure holding force, so that the door body can be opened and closed more stably, safely and conveniently; in addition, by means of the first spring on the key part rocker arm, the second spring on the spring connecting rod, the rocker arm and the bracket, and the hole position of the connecting rivet and the elastic force of the springs are adjusted to provide balance forces and buffering forces for doors with different weights, so that the adaptability is strong; and meanwhile, the position of the supporting frame is rotated to quickly mount the oven door body or quickly demount the oven door body and the oven body.

### BRIEF DESCRIPTION OF THE DRAWINGS

FIG. 1 is a perspective assembly diagram of a hinge.

FIG. 2 is a perspective diagram of the hinge.

FIG. 3 is a schematic diagram of the hinge when a door body is closed.

FIG. 4 is a schematic diagram of the hinge when the door body is opened.

FIG. 5 is a schematic diagram in which a supporting frame supports and fixes a hinge base when a door is mounted.

### DETAILED DESCRIPTION OF THE EMBODIMENTS

The present invention will be further described below in combination with the accompany drawings.

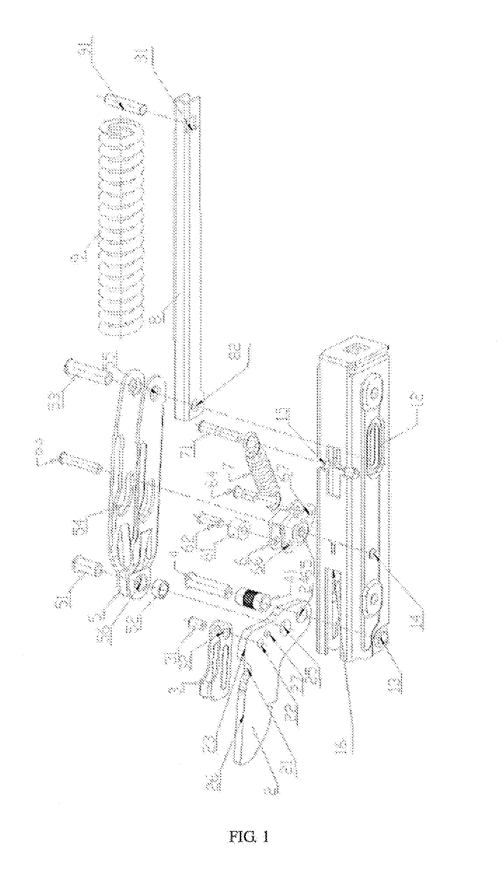

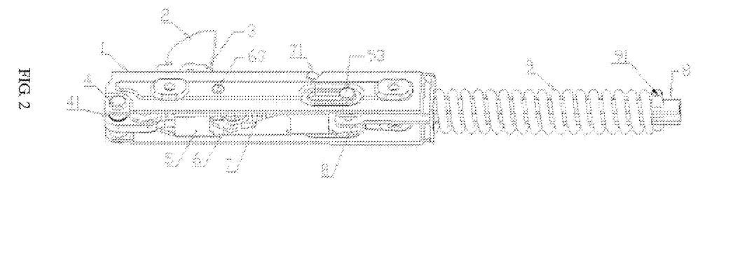

As shown in FIG. 1 and FIG. 2, the hinge includes a hinge base 1, a hinge arm 2 movably arranged with the hinge base, and a supporting frame 3 and a bracket 5 arranged between the hinge base and a movable arm, the supporting frame 3 and the bracket 5 respectively include two clamping pieces arranged in parallel, a rocker arm 6 and a spring connecting rod 8 are arranged in cooperation with the bracket, a first spring 7 is arranged between the rocker arm and the bracket, a second spring 9 is sleeved on the spring connecting rod, the rocker arm 6 body includes two clamping pieces arranged in parallel, a first end hole 66 is arranged on the rocker arm body, a rocker arm rivet 62 penetrates through the first end hole 66 of the rocker arm, a roller 61 is sleeved on the rocker arm rivet and is clamped in the two parallel clamping pieces of the rocker arm body, and clamping positions 21 which are mutually clamped when the rocker arm and the hinge arm are located at first limit positions and side faces 23 of the hinge arm which are mutually propped when the rocker arm and the hinge arm are located at second limit positions are arranged on the hinge arm in cooperation with the roller; specifically, a center hole 65 is further arranged on the rocker arm body, a middle slot hole 54 is arranged on the body of the corresponding bracket 5, a fixing hole 14 is arranged on the hinge seat 1, and a shaft 63 penetrates through the center hole, the middle slot hole and the fixing hole for coaxially connecting the rocker arm, the bracket and the hinge seat; a second end hole 67 is arranged on the other end of the rocker arm body, a connecting shaft 64 penetrates through the second end hole, and a first end hook of the first spring 7 is hung on the connecting shaft and is clamped by the two parallel clamping pieces of the rocker arm body; a first seat hole 13 is arranged on a first end of the connecting seat 1, a first connecting hole 24 is correspondingly arranged on the first end of the hinge arm 2, and the hinge arm is movably connected with the connecting seat by a hinge rivet 4 penetrating through the first seat hole 13 and a hinge sleeve 41 sleeved on the hinge rivet; a clamping hole 15 is arranged at a top end of the hinge seat 1, a clamping shaft 71 is correspondingly arranged, and a second end of the first spring 7 is hung on the clamping shaft; an elongated slot 12 is arranged on the body of the hinge seat 1, a mounting hole 82 is arranged in the first end of the spring connecting rod 8, a second bracket hole 55 is arranged on the second end of the bracket 5, and a long shaft 53 sequentially penetrates through the second bracket hole 55, the mounting hole 82 and the elongated slot 12 for coaxially connecting the hinge seat, the spring connecting rod and the bracket; a bracket end hole 56 is arranged on the first end of the bracket 5, a hinge hole 25 is correspondingly arranged on the hinge arm 2, a bracket rivet 51 penetrates through the bracket end hole 56 and the hinge hole 25 for coaxially connecting the bracket with the hinge seat, and an oilless bearing 52 is sleeved on the bracket rivet 51 and is clamped by the two parallel clamping pieces of the bracket; a top hole 22 is arranged at a top of the hinge arm, a supporting hole 32 is arranged on the second end of the supporting frame 3, and a supporting rivet 31 penetrates through the top hole 22 and the supporting hole 32 for coaxially connecting the hinge arm and the supporting frame; and a neck 81 is arranged on the other end of the spring connecting rod 8, and a pin shaft 91 penetrates through the neck for limiting the other end of the second spring 9.

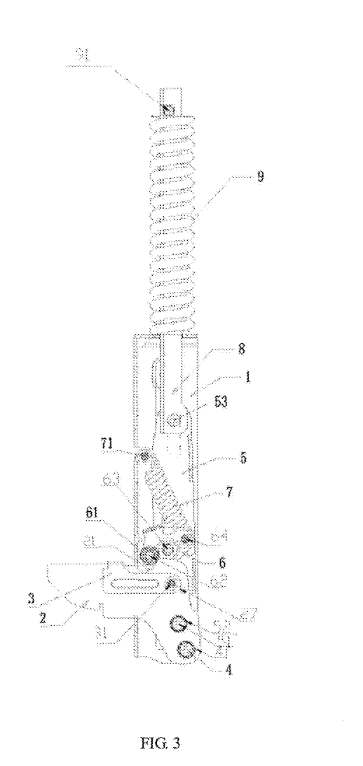

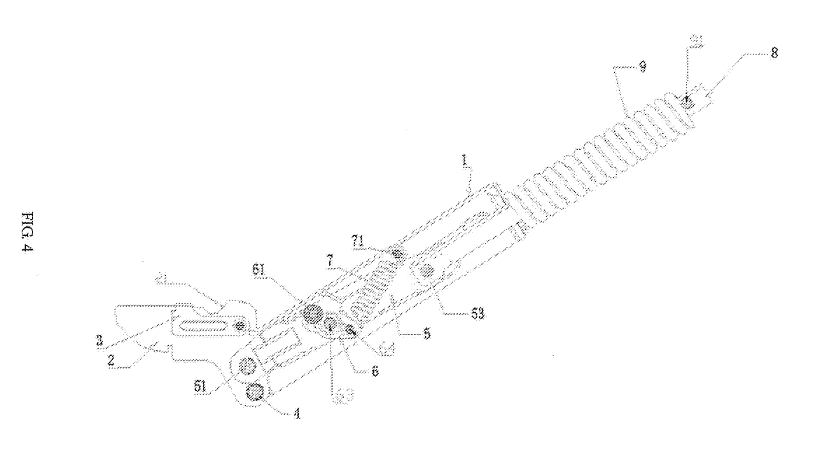

As shown in FIG. 3 and FIG. 4, when in use, an oven door is pulled to drive the hinge base 1 to rotate around the hinge arm 2, high points of the clamping positions 21 are originally arranged below the roller 61, when the angle between the hinge arm and the hinge seat reaches a certain degree, the high points of the clamping positions 21 skip from the lower side of the roller 61, and the side faces 23 of the hinge arm are propped against the side faces of the roller to reach a new balance; in the process, the hinge base rotates to drive the linkage of the bracket, the rocker arm and the spring connecting rod, so that the first spring serving as a pressure spring recovers from a compression state to the original state, and a specific range is that the hinge arm rotates between 25 and 85 degrees; meanwhile, the hinge rotates the hinge base to compress the second spring serving as the pressure spring, a supporting force is provided for the hinge arm by the bracket, and the hinge arm and the door body can stay at any angle between 25 and 85 degrees; when the door body is closed, the door body drives the hinge base to rotate, a pressure is provided for the roller by the rocker arm by means of the tension of the first tension spring, the roller is propped against the side face of the hinge arm, so that the door body is quickly closed within 25 degrees, and the door body has a certain pressure holding force, so that the door body can be closed quickly; meanwhile, since the oval elongated slot 12 is arranged on the hinge seat, the second spring can be conveniently stretched by the bracket to adjust the forces of the angles; and the long shaft 53 is arranged in cooperation with the elongated slot to facilitate rolling of the long shaft rolls in the elongated slot, so that the abrasive resistance of contact elements can be improved.

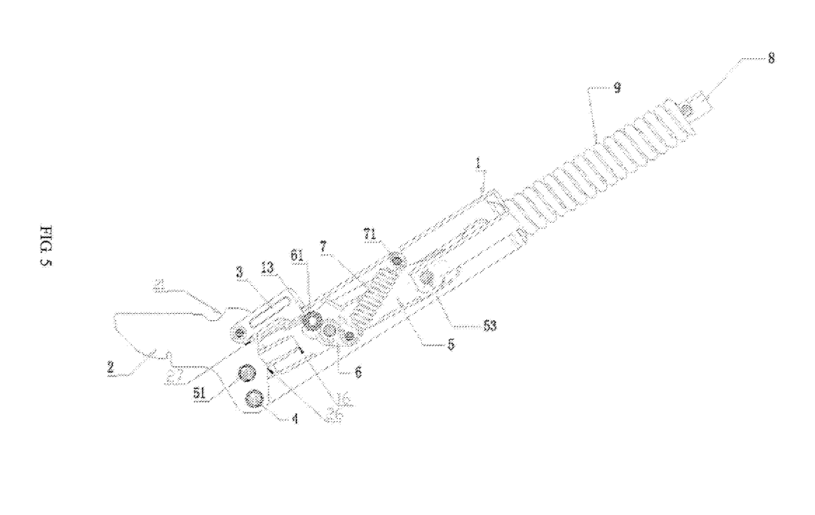

As shown in FIG. 5, when the oven door is mounted, the supporting frame is rotated to the circular boss 27 of the hinge arm at first and then is rotated to the hinge arm, the supporting frame is supported at a limiting groove 16 of the hinge base, the hinge arm 2 is inserted into the oven body, the supporting frame is rotated to another long side face 26 relative to the side faces 23 of the clamping positions 21 of the hinge arm, and the position of the supporting frame is rotated to quickly mount the oven door body or quickly demount the oven door body and the oven body.

1. A hinge, comprising a hinge base (1), a hinge arm (2) movably arranged with the hinge base, and a supporting frame (3) and a bracket (5) arranged between the hinge base and a movable arm, wherein the supporting frame (3) and the bracket (5) respectively include two clamping pieces arranged in parallel, a rocker arm (6) and a spring connecting rod (8) are arranged in cooperation with the bracket, a first spring (7) is arranged between the rocker arm and the bracket, a second spring (9) is sleeved on the spring connecting rod, wherein the rocker arm (6) body includes two clamping pieces arranged in parallel, a first end hole (66) is arranged on the rocker arm body, a rocker arm rivet (62) penetrates through the first end hole (66) of the rocker arm, a roller (61) is sleeved on the rocker arm rivet and is clamped in the two parallel clamping pieces of the rocker arm body, clamping positions (21) which are mutually clamped when the rocker arm and the hinge arm are located at first limit positions and side faces (23) of the hinge arm which are mutually propped when the rocker arm and the hinge arm are located at second limit positions are arranged on the hinge arm in cooperation with the roller.

2. The hinge of claim 1, wherein a center hole (65) is further arranged on the rocker arm body, a middle slot hole (54) is arranged on the body of the corresponding bracket (5), a fixing hole (14) is arranged on the hinge seat (1), and a shaft (63) penetrates through the center hole, the middle slot hole and the fixing hole for coaxially connecting the rocker arm, the bracket and the hinge seat.

3. The hinge of claim 1, wherein a second end hole (67) is arranged on the other end of the rocker arm body, a connecting shaft (64) penetrates through the second end hole, and a first end hook of the first spring (7) is hung on the connecting shaft and is clamped by the two parallel clamping pieces of the rocker arm body.

4. The hinge of claim 1, wherein a first seat hole (13) is arranged on a first end of the connecting seat (1), a first connecting hole (24) is correspondingly arranged on the first end of the hinge arm (2), and the hinge arm is movably connected with the connecting seat by a hinge rivet (4) penetrating through the first seat hole (13) and a hinge sleeve (41) sleeved on the hinge rivet.

5. The hinge of claim 1, wherein a clamping hole (15) is arranged at a top end of the hinge seat (1), a clamping shaft (71) is correspondingly arranged, and a second end of the first spring (7) is hung on the clamping shaft.

6. The hinge of claim 1, wherein an elongated slot (12) is arranged on the body of the hinge seat (1), a mounting hole (82) is arranged in the first end of the spring connecting rod (8), a second bracket hole (55) is arranged on the second end of the bracket (5), and a long shaft (53) sequentially penetrates through the second bracket hole (55), the mounting hole (82) and the elongated slot (12) for coaxially connecting the hinge seat, the spring connecting rod and the bracket.

7. The hinge of claim 1, wherein a bracket end hole (56) is arranged on the first end of the bracket (5), a hinge hole (25) is correspondingly arranged on the hinge arm (2), a bracket rivet (51) penetrates through the bracket end hole (56) and the hinge hole (25) for coaxially connecting the bracket with the hinge seat, and an oilless bearing (52) is sleeved on the bracket rivet (51) and is clamped by the two parallel clamping pieces of the bracket.

8. The hinge of claim 1, wherein a top hole (22) is arranged at a top of the hinge arm, a supporting hole (32) is arranged on the second end of the supporting frame (3), and a supporting rivet (31) penetrates through the top hole (22) and the supporting hole (32) for coaxially connecting the hinge arm and the supporting frame.

9. The hinge of claim 1, wherein a neck (81) is arranged on the other end of the spring connecting rod (8), and a pin shaft (91) penetrates through the neck for limiting the other end of the second spring (9).

10. The hinge of claim 1, wherein a circular boss (27) is arranged on the hinge arm for controlling a rotation angle of the supporting frame.
